(19) United States
(12) Patent Application Publication
(10) Pub. No.: US 2012/0045998 A1
(43) Pub. Date: Feb. 23, 2012

(54) TESTING SYSTEM AND MEASURING METHOD THEREOF FOR MEASURING WIRELESS NETWORK SIGNAL

(75) Inventor: Chiu-Han HSIAO, Taipei County (TW)

(73) Assignee: INSTITUTE FOR INFORMATION INDUSTRY, Taipei (TW)

(21) Appl. No.: 12/869,898

(22) Filed: Aug. 27, 2010

(30) Foreign Application Priority Data
Aug. 19, 2010 (TW) 099127731

(51) Int. Cl. H04B 17/00

(52) U.S. Cl. 455/67.14

(57) ABSTRACT

A testing system and measuring method thereof for measuring wireless network signal are provided. The testing system comprises a control switch, a first base station emulator and a signal measurer. The first base station emulator and the signal measurer connect to the control switch respectively. A device under test (DUT) connects with the testing system via the control switch. The first base station emulator transmits a first channel setting signal to the DUT via the control switch so that the DUT can communicate with the testing system via a first channel. The first base station emulator transmits a plurality of first testing messages to the DUT via the control switch so that the DUT can transmit a plurality of first response messages back according to the first testing messages. The control switch further receives the first response messages from the DUT and then transmits them to the first base station emulator and to the signal measurer at the same time. The first base station emulator calculates a first bit error rate and the signal measurer determines a first signal quality of the DUT both according to the first response messages.

### FIELD

This application claims priority to Taiwan Patent Application No. 099127731, filed on Aug. 19, 2010, which is hereby incorporated by reference.

### FIELD

The present invention relates to a testing system and a measuring method thereof for measuring a wireless network signal. More particularly, the wireless network signal testing system and the measuring method thereof of the present invention makes the tests on signal transmission and signal reception synchronously and is able to automatically switch between testing channels by use of multiple base station emulators.

### BACKGROUND

As wireless network technologies become increasingly sophisticated and owing to advantages thereof such as convenience in use and high mobility, various products for use in wireless networks have been developed. Each time when a new kind of mobile device is to be put into use in a wireless network, necessary tests must be made on the mobile device beforehand in order to enhance stability of the mobile device in the wireless network.

In a conventional testing system, when a signal test is to be made on a device under test (DUT), the DUT is connected to a switch of the testing system at first so that a connection can be established between the DUT and the testing system. Thereafter, a base station emulator of the testing system sets a radio frequency of the DUT to a minimum central frequency of the operating frequency range, and then the testing system begins to measure a wireless signal of the DUT.

More specifically, the process of measuring the wireless signal is divided into at least two portions, a first of which is to make a test on signal transmission of the DUT and a second is to make a test on signal reception of the DUT. However, for the conventional testing system, when a test is being made on signal transmission of the DUT, devices for making a test on signal reception of the DUT will remain idle. Similarly, when a test is being made on signal reception of the DUT, devices for making a test on signal transmission of the DUT will also remain idle. As a consequence, duration of the test is extended, leading to a low testing efficiency.

Moreover, after the DUT has been tested at a radio frequency that is the minimum central frequency of the operating range, the base station emulator of the testing system has to set the radio frequency of the DUT to a medium or a maximum central frequency of the operating frequency range to further make the aforesaid test. The purpose of making tests at the minimum, the medium and the maximum central frequencies respectively is to obtain test results in the whole specified radio frequency range so as to ensure proper service of the DUT. However, the conventional testing system usually has only a single base station emulator, so when the central frequency is to be switched to the next frequency value, the radio frequency devices used by the base station emulator must be re-configured. In this case, an idle status will also occur to the whole testing process, and the next stage of the test can not be started until the base station emulator is switched to the next central frequency.

Accordingly, efforts still have to be made in the art to overcome the shortcoming of the conventional testing system that a lot of idle statuses occur during a test so that the test can be made in a more efficient and more stable way.

### SUMMARY

To address the aforementioned deficiencies with the aforesaid testing system that it tends to cause idle statuses, the objective of the present invention is to provide a testing system and a measuring method thereof for measuring a wireless network signal. The testing system and the measuring method thereof according to the present invention reduce duration of a measuring process remarkably by using multiple base station emulators and measuring a transmitting signal and a receiving signal of a device under test (DUT) simultaneously.

To achieve the aforesaid objective, certain embodiment of the present invention provide a testing system for measuring a wireless network signal. The testing system comprises a control switch, a first base station emulator and a signal measurer. The first base station emulator and the signal measurer connect to the control switch respectively. A DUT establishes a network connection with the testing system via the control switch. The first base station emulator is configured to transmit a first channel setting signal to the DUT via the control switch so that, according to the first channel setting signal, the DUT communicates with the testing system via a first channel, and is configured to transmit a plurality of first testing messages to the DUT via the control switch so that the DUT transmits a plurality of first response messages according to the first testing messages. The control switch is configured to receive the plurality of first response messages and then transmit the plurality of first response messages to the first base station emulator and the signal measurer simultaneously. The first base station emulator is further configured to calculate a first bit error rate according to the plurality of first response messages, and the signal measurer is configured to determine a first signal quality of the DUT according to the plurality of first response messages.

To achieve the aforesaid objective, certain embodiment of the present invention further provide a wireless network signal measuring method for a testing system. The testing system comprises a control switch, a first base station emulator and a signal measurer. The first base station emulator and the signal measurer connect to the control switch respectively, and the testing system establishes a network connection with a DUT via the control switch. The wireless network signal measuring method comprises the following steps of: (a) enabling the first base station emulator to transmit a first channel setting signal to the DUT via the control switch so that, according to the first channel setting signal, the DUT communicates with the testing system via a first channel; (b) after the step (a), enabling the first base station emulator to transmit a plurality of first testing messages to the DUT via the control switch so that the DUT transmits a plurality of first response messages according to the plurality of first testing messages; (c) enabling the control switch to receive the plurality of first response messages from the DUT and then transmit the plurality of first response messages to the first base station emulator and the signal measurer simultaneously; (d) enabling the first base station emulator to calculate a first bit error rate according to the plurality of first response messages; and (e) enabling the signal measurer to determine a first signal quality of the DUT according to the first response messages.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view depicting a testing system of a first example embodiment;

FIG. 2 is a schematic view depicting a signal flow of the first example embodiment; and

FIGS. 3A-3B depict a flowchart of a wireless network signal measuring method of a second example embodiment.

### DETAILED DESCRIPTION

In the following description, the present invention will be explained with reference to example embodiments thereof. However, these examples are not intended to limit the present invention to any specific environment, embodiment, example, application or particular implementation described in these example embodiments. Therefore, description of these example embodiments is only for purpose of illustration rather than to limit the present invention. It should be appreciated that, in the following example embodiments and the attached drawings, elements not needed to explain the example embodiments of the present invention are omitted from depiction.

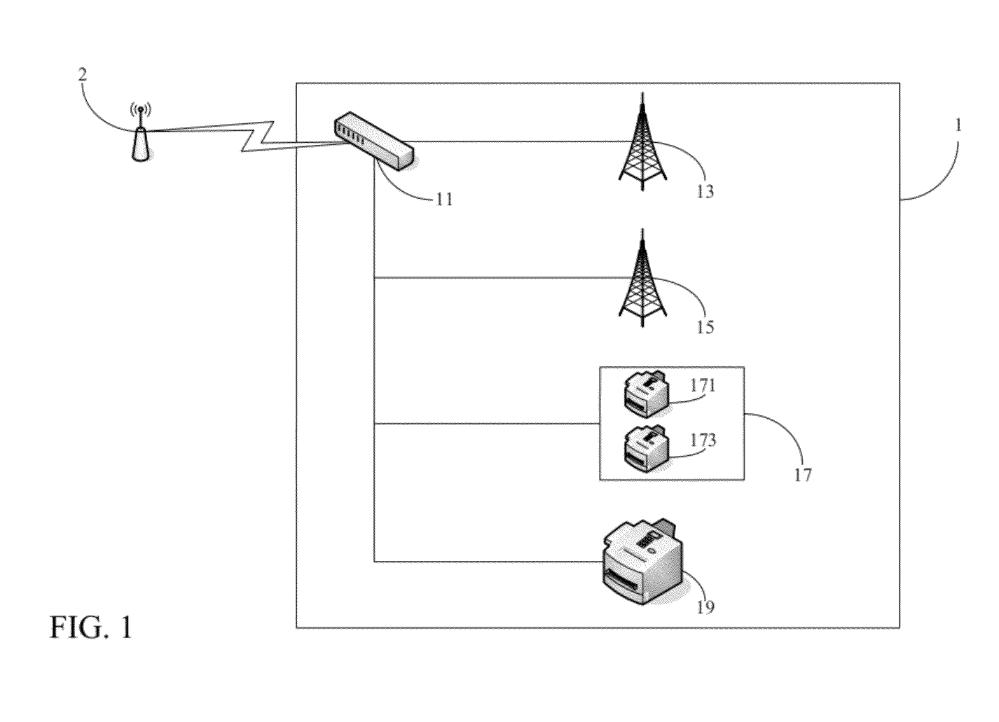

FIG. 1 shows a first embodiment of the present invention, which is a testing system 1. The testing system 1 comprises a control switch 11, a first base station emulator 13, a second base station emulator 15, a signal measurer 17 and a signal generator 19. As shown, the first base station emulator 13, the second base station emulator 15, the signal measurer 17 and the signal generator 19 connect to the control switch 11 respectively. The testing system 1 establishes a network connection with a device under test (DUT) 2 via the control switch 11 so that the testing system 1 can receive a wireless network signal from the DUT 2 via the control switch 11 and makes a test on the wireless network signal. It shall be particularly appreciated that, the control switch 11 used in the first embodiment is a switch with processing and operation capabilities; however, in other examples, the control switch 11 may also be divided into a control server and a switch.

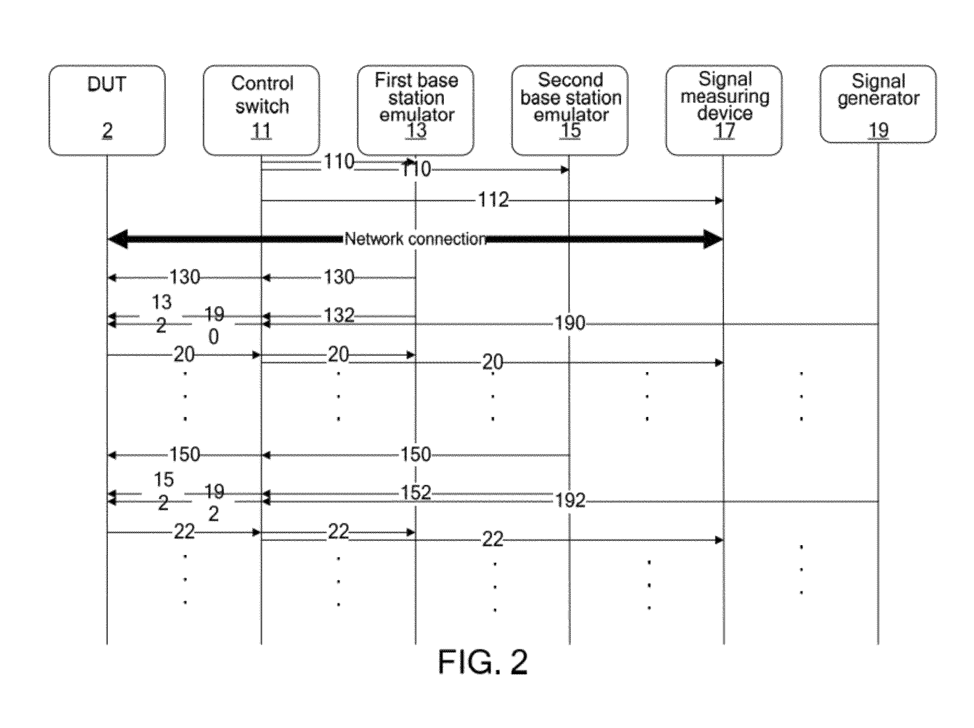

Next, refer to FIG. 2 together. Firstly, the testing system 1 has to make related settings specific to the environment to be tested. The control switch 11 transmits a reception test setting 110 to the first base station emulator 13 and the second base station emulator 15 simultaneously to make settings related to signal reception on the base station emulators so that the base station emulators can subsequently receive and process a wireless network signal transmitted by the DUT 2. Here, it shall be particularly appreciated that, the reception test setting 110 transmitted by the control switch 11 to the first base station emulator 13 and the second base station emulator 15 in FIG. 2 may be a single signal that is transmitted simultaneously; and the purpose of labeling it with two signal lines in FIG. 2 is to emphasize that the signal is transmitted to different base station emulators respectively by a same control switch, but is not to limit the number of signals and the way in which the signal is transmitted. Next, the control switch 11 transmits a transmission test setting 112 to the signal measurer 17 to, similarly, make settings related to signal transmission on the signal measurer 17 so that the signal measurer 17 can subsequently measure a wireless network signal transmitted by the DUT 2.

After the aforesaid settings of the testing system 1 are made, the first base station emulator 13 makes a test on the wireless signal of the DUT 2 firstly. Specifically, after the aforesaid settings are made, the testing system 1 establishes a network connection with the DUT 2 via the control switch 11, and then the first base station emulator 13 transmits a first channel setting signal 130 to the DUT 2 via the control switch 11 so that the DUT 2 communicates with the testing system 1 via a first channel (not shown) according to the first channel setting signal 130.

It shall be particularly appreciated that, there is a channel range for communication between the testing system 1 and the DUT 2. If a test is made at each frequency in the channel range, then the testing process would be inefficient. Therefore, in order to shorten the testing process, the test is made only at a minimum, a medium and a maximum central frequency of the channel range. In this way, the complex process of making a test at each frequency in the channel range can be obviated, while the objective of making a test in the whole channel range can still be achieved. In this embodiment, the aforesaid first channel is just the minimum central frequency.

Next, after the DUT 2 confirms that it is communicating with the first base station emulator 13 via the first channel, the first base station emulator 13 begins to transmit a plurality of first testing messages 132 to the DUT 2, and the DUT 2 responds with a plurality of first response messages 20 in sequence according to the first testing messages 132 so that the testing system 1 can make a signal test. Further speaking, after receiving the first response messages 20 from the DUT 2, the control switch 11 transmits the first response messages 20 to the first base station emulator 13 and the signal measurer 17 simultaneously. After receiving the first response messages 20 in sequence, the first base station emulator 13 can calculate a first bit error rate according to the first response messages 20; and meanwhile, the signal measurer 17 can determine a first signal quality of the DUT 2 according to the first response messages 20.

In more detail, the first base station emulator 13 can determine whether the first testing messages 132 transmitted by the first base station emulator 13 are properly received by the DUT 2 according to the first response messages 20 transmitted by the DUT 2. In brief, if the DUT 2 fails to receive the first testing messages 132 transmitted by the first base station emulator 13, then it will not transmit the first response messages 20. Thus, the first base station emulator 13 can calculate the first bit error rate according to the aforesaid mechanism to determine whether the reception behavior of the DUT 2 is normal. As unknown noises that interfere with the communication often arise in the real-world network environment, the testing system 1 of the present invention further comprises the signal generator 19, which is configured to transmit a plurality of interfering messages 190 to the DUT 2 simultaneously when the first base station emulator 13 is transmitting the first testing messages 132 to the DUT 2 via the control switch 11. Thus, a more realistic environmental testing effect can be provided.

On the other hand, the signal measurer 17 can, after receiving the first response messages 20, determine a first signal quality of the DUT 2. In detail, the signal measurer 17 may comprise a power measurer 171 configured to determine a signal strength that the DUT 2 is able to transmit via the first channel according to the first response messages 20 transmitted by the DUT 2; further, the signal measurer 17 may comprise a signal spectrum analyzer 173 configured to analyze a signal spectrum of a network signal transmitted by the DUT 2 according to the first response messages 20. Thereby, according to the signal strength and the signal spectrum of the DUT 2 in the first channel that are measured by the signal measurer 17, the signal measurer 17 can further determine whether the DUT 2 meets requirements of various wireless network specifications.

So far, the testing system 1 has tested the wireless network signal of the DUT 2 at the minimum central frequency. Next, the testing system 1 must be further switched to the medium central frequency to make the test on the DUT 2. Next, please refer to FIG. 2. Specifically, after the first base station emulator 13 of the testing system 1 has completed the test on the DUT 2 in the first channel (i.e., at the minimum central frequency), the second base station emulator 15 of the testing system 1 automatically performs a handover procedure and transmits a second channel setting signal 150 to the DUT 2 via the control switch 11 so that the DUT 2 can communicate with the testing system 1 via a second channel according to the second channel setting signal 150. The second channel in this embodiment is the medium central frequency of the communication channel range.

It shall be particularly emphasized that, the testing system 1 has initially made related settings on the second base station emulator 15 through the reception test setting 110, so when the first base station emulator 13 is performing the aforesaid testing steps on the DUT 2, the second base station emulator 15 can stay in a standby mode in the second channel so that, once the connection between the DUT 2 and the first base station emulator 13 is terminated, the DUT 2 can be automatically and directly switched to connect to the second base station emulator 15 for a related test. Thus, the unnecessary time that would otherwise be needed by a testing system with a single base station emulator to re-configure a channel can be remarkably saved.

Next, similarly, after the DUT 2 confirms that it is communicating with the second base station emulator 15 via the second channel, the second base station emulator 15 begins to transmit a plurality of second testing messages 152 to the DUT 2, and the DUT 2 responds with a plurality of second response messages 22 in sequence according to the second testing messages 152 so that the testing system 1 can make a test. After receiving the second response messages 22 from the DUT 2, the control switch 11 transmits the second response messages 22 to the second base station emulator 15 and the signal measurer 17 simultaneously. After receiving the second response messages 22 in sequence, the second base station emulator 15 can calculate a second bit error rate according to the second response messages 22, and the signal measurer 17 can determine a second signal quality of the DUT 2 according to the second response messages 22.

The second bit error rate is calculated in the same way as the first bit error rate. And similarly, when the second base station emulator 15 is transmitting the second testing messages 152 to the DUT 2 via the control switch 11, the signal generator 19 may also transmit a plurality of interfering messages 192 to the DUT 2 simultaneously to improve reality of the testing environment. Also, the second signal quality of the DUT 2 is measured by the signal measurer 17 in the same way as the first signal quality. Accordingly, identical contents will not be further described herein. In a word, the primary function of the second base station emulator 15 is to save a substantial amount of idle time that would otherwise be needed for a single base station emulator to switch between frequencies.

Similarly, when the second base station emulator 15 of the testing system 1 is making a test on the DUT 2, the first base station emulator 13 can be switched to the maximum central frequency of the communication channel range so that the testing system 1 can, after completing the test on the DUT 2 in the second channel (i.e., at the medium central frequency), be automatically and directly switched back to the first base station emulator 13 to make a subsequent test at the maximum central frequency. However, it shall be particularly emphasized that, description of the first embodiment is not intended to limit the number of the base station emulators of the present invention to be two, and use of more than two base station emulators may also be readily envisaged by those skilled in the art based on the above disclosure. In addition, because the testing system 1 is primarily used to measure a status of a wireless network signal of the DUT 2 but not to adjust or ensure that the wireless network signal of the DUT 2 is normal, results of the measurement are only for reference in the test and do not need to fall within the normal range.

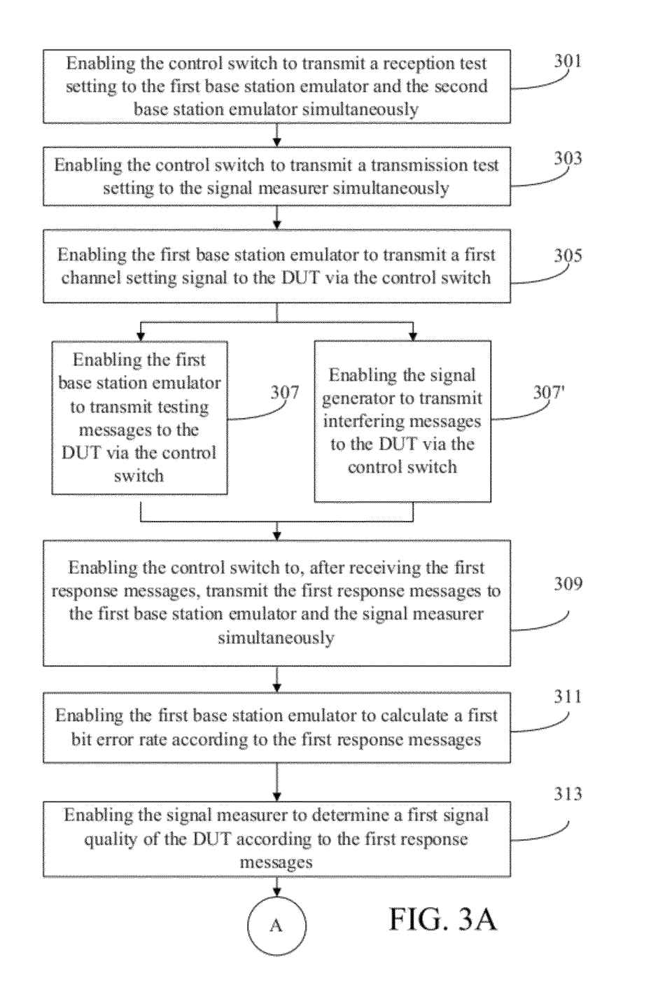

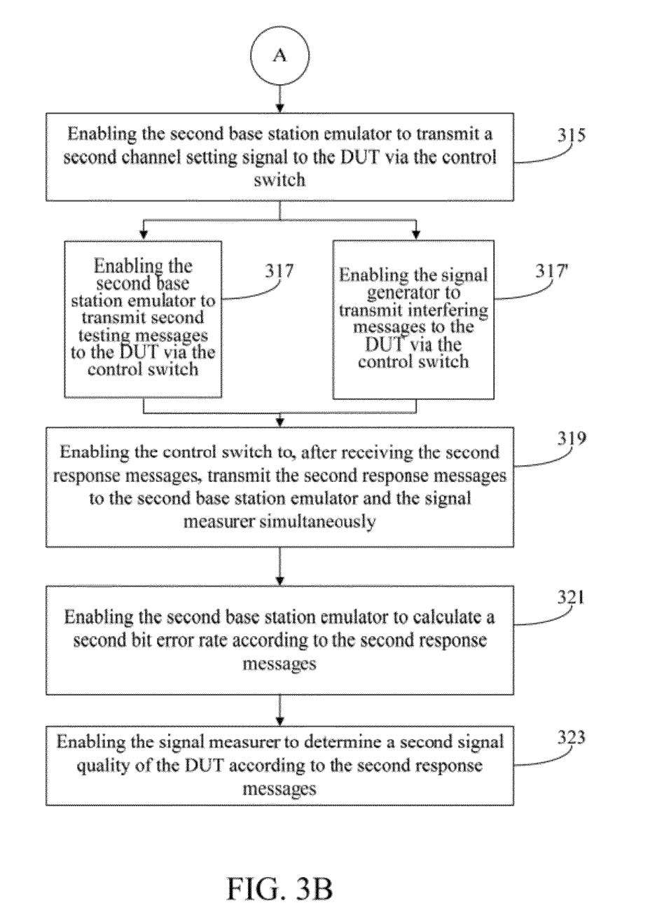

A second embodiment of the present invention is a wireless network signal measuring method for a testing system (e.g., the testing system 1 of the first embodiment), a flowchart of which is shown in FIGS. 3A-3B. The testing system comprises a control switch, a first base station emulator, a second base station emulator, a signal measurer and a signal generator. The first base station emulator, the second base station emulator, the signal measurer and the signal generator connect to the control switch respectively, and the testing system establishes a network connection with a DUT via the control switch. Steps of the wireless network signal measuring method of the second embodiment are described in detail as follows.

Firstly, the testing system has to make related settings specific to the environment to be tested. Accordingly, step 301 is executed to enable the control switch to transmit a reception test setting to the first base station emulator and the second base station emulator simultaneously to make settings related to signal reception on the base station emulators so that the base station emulators can subsequently receive and process a wireless network signal transmitted by the DUT. Next, step 303 is executed to enable the control switch to transmit a transmission test setting to the signal measurer to, similarly, make settings related to signal transmission on the signal measurer so that the signal measurer can subsequently measure a wireless network signal transmitted by the DUT.

After the aforesaid settings of the testing system are made, the first base station emulator makes a wireless signal test on the DUT. Specifically, step 305 is executed firstly to enable the first base station emulator to transmit a first channel setting signal to the DUT via the control switch so that the DUT can communicate with the testing system via a first channel according to the first channel setting signal. Similarly, in order to shorten the testing process, a minimum, a medium and a maximum central frequency in the channel range for communication between the testing system and the DUT are selected, and the test is made at these three frequencies. In this embodiment, the aforesaid first channel is just the minimum central frequency.

Next, step 307 is executed to, after the DUT confirms that it is communicating with the first base station emulator via the first channel, enable the first base station emulator to transmit a plurality of first testing messages to the DUT. Then, the DUT can respond with a plurality of first response messages in sequence according to the first testing messages so that the testing system can make a signal test. In addition, when the step 307 is being executed, step 307′ may also be executed simultaneously to enable the signal generator to transmit a plurality of interfering messages to the DUT, thereby providing a more realistic environmental testing effect.

Next, step 309 is executed to enable the control switch to, after receiving the first response messages from the DUT, transmit the first response messages to the first base station emulator and the signal measurer simultaneously. Then, step 311 is executed to enable the first base station emulator to, after receiving the first response messages in sequence, calculate a first bit error rate according to the first response messages; and meanwhile, step 313 is executed to enable the signal measurer to determine a first signal quality of the DUT according to the first response messages. The signal measurer may comprise a power measurer configured to determine a signal strength that the DUT is able to transmit according to the first response messages transmitted by the DUT; and further, the signal measurer may comprise a signal spectrum analyzer configured to analyze a signal spectrum of a network signal transmitted by the DUT according to the first response messages. It shall be particularly appreciated that, because different tests are made in the step 311 and the step 313 respectively, the sequence of the step 311 and the step 313 can be reversed but is not limited to what described in this embodiment.

So far, the testing system has completed the wireless network signal test on the DUT at the minimum central frequency. Next, the testing system must be further switched to the medium central frequency to make a test on the DUT. Referring to FIG. 3B, specifically, after the first base station emulator of the testing system has completed the test on the DUT in the first channel (i.e., at the minimum central frequency), the second base station emulator of the testing system automatically performs a handover procedure, and step 315 is executed to enable the second base station emulator to transmit a second channel setting signal to the DUT via the control switch so that the DUT can communicate with the testing system via a second channel according to the second channel setting signal. Here, the second channel in this embodiment is the medium central frequency of the communication channel range.

The testing system has initially made related settings on the second base station emulator by receiving the test settings, so when the first base station emulator is making the test of the steps 305-313 on the DUT, the second base station emulator can stay in a standby mode in the second channel so that, once the connection between the DUT and the first base station emulator is terminated, the DUT can be automatically and directly switched to connect to the second base station emulator for a related test. Thus, the unnecessary time that would otherwise be needed by a testing system with a single base station emulator to re-configure a channel can be remarkably saved.

Next, similarly, the step 315 is executed to enable the second base station emulator to transmit a second channel setting signal to the DUT via the control switch so that the DUT can communicate with the testing system via a second channel according to the second channel setting signal. In this embodiment, the aforesaid second channel is just the medium central frequency.

Next, step 317 is executed to, after the DUT confirms that it is communicating with the second base station emulator via the second channel, enable the second base station emulator to transmit a plurality of second testing messages to the DUT. Then, the DUT can respond with a plurality of second response messages in sequence according to the second testing messages so that the testing system can make a signal test. Similarly, when the step 317 is being executed, step 317′ may also be executed simultaneously to enable the signal generator to transmit a plurality of interfering messages to the DUT.

Next, step 319 is executed to enable the control switch to, after receiving the second response messages from the DUT, transmit the second response messages to the second base station emulator and the signal measurer simultaneously. Then, step 321 is executed to enable the second base station emulator to, after receiving the second response messages in sequence, calculate a second bit error rate according to the second response messages; and meanwhile, step 323 is executed to enable the signal measurer to determine a second signal quality of the DUT according to the second response messages. Here, the power measurer of the signal measurer can also determine a signal strength that the DUT is able to transmit in the second channel according to the second response messages transmitted by the DUT; and the signal spectrum analyzer of the signal measurer can also analyze a signal spectrum of a network signal transmitted by the DUT via the second channel according to the second response messages. Similarly, because different tests are made in the step 321 and the step 323, the sequence of the step 321 and the step 323 can be reversed but is not limited to what described in this embodiment.

According to the above descriptions, the system and the method of the present invention can make tests of transmission and reception simultaneously in a wireless network signal test, and further use multiple base station emulators to automatically accomplish switching between different channels. Thus, a substantial amount of idle time that would otherwise be needed in a conventional test can be saved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless network signal measuring method for use in a testing system, the testing system comprising a control switch, a first base station emulator and a signal measurer, the first base station emulator and the signal measurer connecting to the control switch respectively, the testing system establishing a network connection with a device under test (DUT) via the control switch, the wireless network signal measuring method comprising:
(a) enabling the first base station emulator to transmit a first channel setting signal to the DUT via the control switch so that, according to the first channel setting signal, the DUT communicates with the testing system via a first channel;
(b) after the step (a), enabling the first base station emulator to transmit a plurality of first testing messages to the DUT via the control switch so that the DUT transmits a plurality of first response messages according to the first testing messages;
(c) enabling the control switch to receive the first response messages from the DUT and then transmit the first response messages to the first base station emulator and the signal measurer simultaneously;
(d) enabling the first base station emulator to calculate a first bit error rate according to the first response messages; and
(e) enabling the signal measurer to determine a first signal quality of the DUT according to the first response messages.

2. The wireless network signal measuring method as claimed in claim 1, wherein the testing system further comprises a signal generator connecting to the control switch, the step (b) further comprises:
(b1) enabling the signal generator to transmit a plurality of interfering signals to the DUT simultaneously when the first base station emulator is transmitting the first testing messages to the DUT via the control switch.

3. The wireless network signal measuring method as claimed in claim 1, wherein the signal measurer comprises a power measurer, and the first signal quality is a signal strength of the DUT.

4. The wireless network signal measuring method as claimed in claim 1, wherein the signal measurer comprises a signal spectrum analyzer, and the first signal quality is a signal spectrum of the DUT.

5. The wireless network signal measuring method as claimed in claim 1, wherein the testing system further comprises a second base station emulator connecting to the control switch, the wireless network signal measuring method further comprises the following steps after the step (e):
(f) after the step (e), enabling the second base station emulator to automatically transmit a second channel setting signal to the DUT via the control switch so that the DUT communicates with the testing system via a second channel according to the second channel setting signal;
(g) after the step (f), enabling the second base station emulator to transmit a plurality of second testing messages to the DUT via the control switch so that the DUT transmits a plurality of second response messages according to the second testing messages;
(h) after the step (g), enabling the control switch to receive the second response messages from the DUT and then transmit the second response messages to the second base station emulator and the signal measurer simultaneously;
(i) enabling the second base station emulator to calculate a second bit error rate according to the second response messages; and
(j) enabling the signal measurer to determine a second signal quality of the DUT according to the second response messages.

6. The wireless network signal measuring method as claimed in claim 5, wherein the testing system further comprises a signal generator connecting to the control switch, the step (g) further comprises:
(g1) enabling the signal generator to transmit a plurality of interfering signals to the DUT simultaneously when the second base station emulator is transmitting the second testing messages to the DUT via the control switch.

7. The wireless network signal measuring method as claimed in claim 5, wherein the signal measurer comprises a power measurer, and the second signal quality is a signal strength of the DUT.

8. The wireless network signal measuring method as claimed in claim 5, wherein the signal measurer comprises a signal spectrum analyzer, and the second signal quality is a signal spectrum of the DUT.

9. A testing system for measuring a wireless network signal, comprising:
a control switch;
a first base station emulator connecting to the control switch; and
a signal measurer connecting to the control switch,
wherein a DUT establishes a network connection with the testing system via the control switch, the first base station emulator is configured to transmit a first channel setting signal to the DUT via the control switch so that, according to the first channel setting signal, the DUT communicates with the testing system via a first channel, the first base station emulator is further configured to transmit a plurality of first testing messages to the DUT via the control switch so that the DUT transmits a plurality of first response messages according to the first testing messages, the control switch is configured to receive the first response messages and then transmit the first response messages to the first base station emulator and the signal measurer simultaneously, the first base station emulator is further configured to calculate a first bit error rate according to the first response messages, the signal measurer is configured to determine a first signal quality of the DUT according to the first response messages.

10. The testing system as claimed in claim 9, further comprising:
a signal generator, being connected to the control switch and configured to transmit a plurality of interfering signals to the DUT simultaneously when the first base station emulator is transmitting the first testing messages to the DUT via the control switch.

11. The testing system as claimed in claim 9, wherein the signal measurer comprises a power measurer, and the first signal quality is a signal strength of the DUT.

12. The testing system as claimed in claim 9, wherein the signal measurer comprises a signal spectrum analyzer, and the first signal quality is a signal spectrum of the DUT.

13. The testing system as claimed in claim 9, further comprising:
a second base station emulator connecting to the control switch;
wherein the second base station emulator is configured to automatically transmit a second channel setting signal to the DUT via the control switch so that, according to the second channel setting signal, the DUT communicates with the testing system via a second channel, and is configured to transmit a plurality of second testing messages to the DUT via the control switch so that the DUT transmits a plurality of second response messages according to the second testing messages, the control switch is further configured to receive the second response messages and then transmit the second response messages to the second base station emulator and the signal measurer simultaneously, the second base station emulator is further configured to calculate a second bit error rate according to the second response messages, and the signal measurer is configured to determine a second signal quality of the DUT according to the second response messages.

14. The testing system as claimed in claim 13, further comprising:
a signal generator, being connected to the control switch and configured to transmit a plurality of interfering signals to the DUT simultaneously when the second base station emulator is transmitting the second testing messages to the DUT via the control switch.

15. The testing system as claimed in claim 13, wherein the signal measurer comprises a power measurer, and the second signal quality is a signal strength of the DUT.

16. The testing system as claimed in claim 13, wherein the signal measurer comprises a signal spectrum analyzer, and the second signal quality is a signal spectrum of the DUT.
